(19) United States
(12) Patent Application Publication
(10) Pub. No.: US 2010/0329222 A1
(43) Pub. Date: Dec. 30, 2010

(54) MIMO BASED WIRELESS TELECOMMUNICATIONS METHOD AND SYSTEM

(76) Inventors: Paul Hallbjörner, Molndal (SE); Mats H. Andersson, Goteborg (SE)

Correspondence Address: ERICSSON INC., 6300 LEGACY DRIVE, M/S EVR 1-C-11, PLANO, TX, 75024, US

(21) Appl. No.: 12/091,399

(22) PCT Filed: Jan. 11, 2005
(86) PCT No.: PCT/SE2005/001632

§ 371 Date: Jul. 26, 2010

(51) Int. Cl. H04W 4/00; H04B 7/00

(52) U.S. Cl. 370/338; 455/517; 455/422.1

(57) ABSTRACT

A wireless telecommunications system having a plurality of radio base stations, the base stations in the system are arranged for communication with at least one user terminal in accordance with a first principle of wireless telecommunication. The system has at least a first sub-set of the plurality of radio base stations arranged for communication with at least one user terminal in the system in accordance with said first principle but also as MIMO-stations in cooperation with each other. Preferably, said first principle of wireless telecommunication is a principle within cellular telephony.

### TECHNICAL FIELD

The present invention relates to the field of wireless telecommunications systems which comprise a plurality of radio base stations, where the base stations in the system are arranged for communication with at least one user terminal in accordance with a first principle of wireless telecommunication.

### BACKGROUND ART

In wireless telecommunications systems such as, for example, cellular telephony systems, a plurality of base stations are used to cover the area which the system is intended for.

A user communicates with the system via at least one of the base stations, preferably that base station which offers the best signal strength at his location. If and when the user moves to another location, where another base station will offer the best signal strength, the user is “handed over” to that base station instead, i.e. his calls are routed via that base station.

The technology known as MIMO, Multiple Input, Multiple Output, utilizes a multitude of information streams, usually transmitted at one and the same frequency, in order to transmit more information to a user than is possible with one information stream. In order for the information to be transmitted at one and the same frequency, the degree of interference between the streams must be kept at a low level.

One way of ensuring the desired low degree of interference between the information streams is to use one antenna per data stream at both the transmit and receive ends of a MIMO connection.

### DISCLOSURE OF THE INVENTION

The inventors of the present invention have realized that in many systems for wireless communications, such as, for example, cellular telephony, base stations are being deployed with an increasing density, and that this density of base stations can be used to let the system for which the base stations are intended function as a MIMO-system as well as the traditional principle for which the system is intended.

Thus, the present invention discloses a wireless telecommunications system which comprises a plurality of radio base stations, in which system the base stations are arranged for communication with at least one user terminal in accordance with a first principle of wireless telecommunication.

In the system of the invention, at least a first sub-set of the plurality of radio base stations are arranged for communication with at least one user terminal in the system in accordance with said first principle but also as MIMO-stations in cooperation with each other. This means that at least some of the base stations of the system can be “MIMO-stations” which communicate with a user terminal simultaneously, as opposed to previous systems, in which each user is dedicated to a particular base station. The present invention can be used in a variety of existing systems, provided that the user terminal can accept MIMO-communication. Some example of systems within which the present invention can be used are cellular systems for voice, video and data and also so called WiMAX-systems and wireless sensor metworks.

### BRIEF DESCRIPTION OF THE DRAWINGS

The invention will be described in more detail in the following, with reference to the appended drawings, in which

FIG. 1 shows a system according to the invention.

### EMBODIMENT

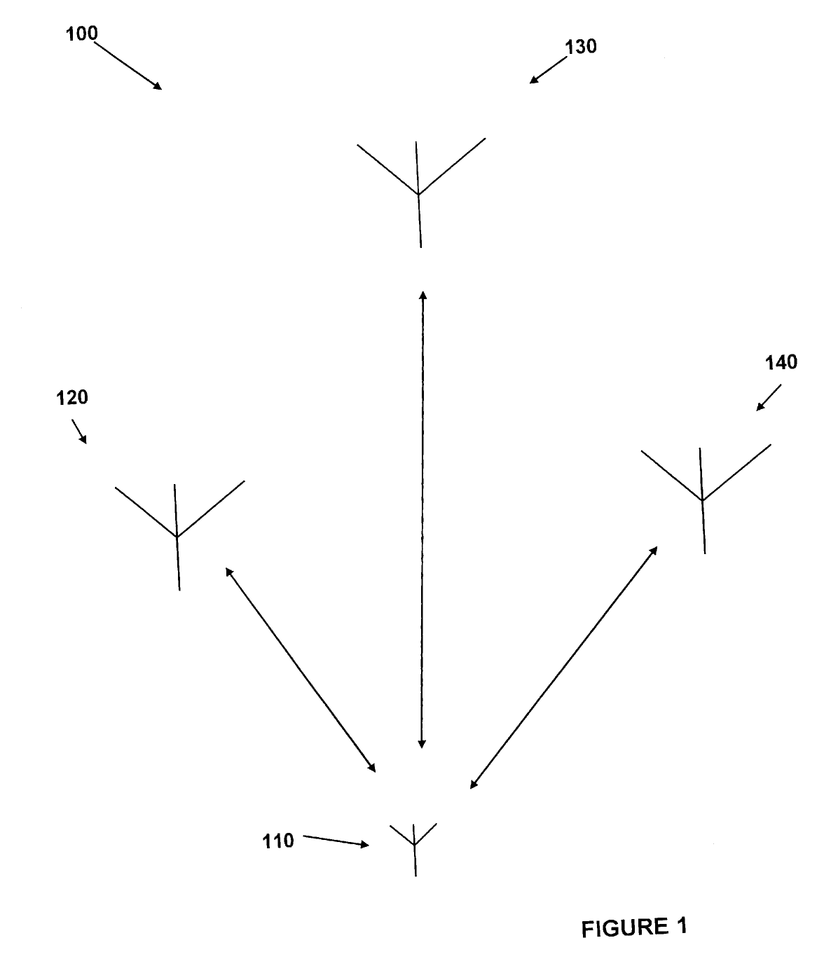

In FIG. 1, a system 100 of the invention is schematically shown. The system is based on a wireless telecommunications system of a standardized kind, such as e.g. a cellular telephony system or a WLAN-system. The invention can be applied both to systems with mobile users and stationary users, the term “stationary” here being intended to refer not only to users who are absolutely fixed, but also to those users who move at a slow pace (compared to users in vehicles), such as, for example, wireless LAN-systems where a user can walk around in an office with his terminal.

Thus, although the invention will in the following be described with reference to a cellular telephony system, this should only be seen as an example which is used to facilitate the understanding of the invention, and is not restrictive regarding the systems to which the invention may be applied.

In FIG. 1, there is shown a user 110 of the system 100. The system 100 as such comprises a plurality of base stations 120, 130, 140, each of which, in a conventional system, would be intended to cover a specific sub-area of the entire area for which the system 100 is intended.

In systems for conventional cellular telephony system, the user 110 can move around in the area covered by the system, and the traffic to and from the user will be handled by that base station which has the strongest signal in the location of the user 110. Thus, in a conventional system, the user 110 will be “handed-over” between the base stations as he moves around in the system, or if the signal quality varies for other reasons.

Accordingly, in conventional systems, more than base station at the time needs to be aware of the user 110, so that hand-over can be prepared in a proper way.

The inventors of the present invention have realized that this fact may be used in order to let more than one base station at a time communicate with the user, in order to increase the amount of data which may be transferred to and from the user simultaneously.

Thus, the system 100 of the invention is essentially a wireless telecommunications system with a plurality of radio base stations 120, 130, 140, in which system the base stations are arranged for communication with at least one user terminal, such as the user 100, in accordance with a first principle of wireless telecommunication, such as the GSM or CDMA-systems.

In the system of the invention, however, at least a first sub-set of the plurality of radio base stations such as the stations 120, 130, 140, are arranged for communication with at least the user 110 in accordance with the mentioned first principle, but also as MIMO-stations in cooperation with each other.

MIMO, Multiple Input, Multiple Output, is a principle according to which a plurality of data streams are transmitted simultaneously to one and the same user, usually on one and the same frequency. In order for the different data streams to not interfere with each other, there needs to be some sort of separation or de-correlation between them, obtained by, for example, example spatial separation between the transmitting (and the receiving) antennas.

According to the invention, at least two of the base stations in the systems can act as MIMO-stations in cooperation with each other. This means that those base stations which act as MIMO-stations would transmit at least one data stream each to the user 110, one antenna at each RBS being used for each data stream.

Since the different base stations are located at different sites, geographically separated from each other, the desired de-correlation between the transmitting stations is obtained “automatically”, as a result of the geography of the system.

Since the system 100 is based on a system for a conventional kind of wireless communication, a number of different scenarios or embodiments can be envisioned for the system of the invention. In a first embodiment, the base stations of the system 100 can act as a system solely according to the conventional principle on which it is based, and then, when a user who can receive MIMO-transmissions enters the coverage area of the system, at least said plurality of radio base stations can switch over to a “MIMO-mode” for communicating with that user.

The fact that this particular user is capable of receiving MIMO-transmissions is suitably detected by the system by means of signalling from the user, preferably in a standardized message in the conventional system on which the invention is based.

In a second embodiment, said plurality of base stations is constantly capable of communicating in “MIMO-mode” as well as in the conventional mode.

Since different data streams are sent from the base stations used for MIMO, the total data which is sent to the user 110 needs to be coordinated and possibly also synchronized from one point in the system. This can be accomplished in a number of different ways: one such way is to let “the next level” in the system, i.e. the level above the base stations, handle the coordination and synchronization of the base stations in question.

Another way of achieving the desired coordination and synchronization is to let one of the base station be a “master station” when it comes to MIMO-communication, in other word that base station would control the other base stations for MIMO-purposes.

The invention is not limited to the examples shown in the description above, but may be freely varied within the scope of the appended claims.

1. A wireless telecommunications system comprising:
a plurality of radio base stations, said base stations in the system being arranged for communication with at least one user terminal in accordance with a first principle of wireless telecommunication; and
at least a first sub-set of the plurality of radio base stations are arranged for communication with at least one user terminal in the system in accordance with said first principle but also as stations operating in accordance with Multiple Input Multiple Output (MIMO) principles in cooperation with each other.

2. The system of claim 1, in which said first principle of wireless telecommunication is cellular telephony.

3. The system of claim 1, in which said first principle of wireless telecommunication is WiMAX.

4. The system of claim 1, in which the MIMO-principle is employed to let at least two of the base stations transmit different data streams on the same frequency to the user terminal simultaneously.
